(19) United States
(12) Patent Application Publication
(10) Pub. No.: US 2015/0020058 A1
(43) Pub. Date: Jan. 15, 2015

(54) Method and System for Prompting Application Update

(71) Applicant: Tencent Technology (Shenzhen) Company Limited, Shenzhen (CN)

(72) Inventors: Hao CAO, Shenzhen (CN); Yanliang LIU, Shenzhen (CN); Erxiao CHEN, Shenzhen (CN)

(73) Assignee: TENCENT TECHNOLOGY (SHENZHEN) COMPANY LIMITED, Shenzhen (CN)

(21) Appl. No.: 14/490,983

(22) Filed: Sep. 19, 2014

Related U.S. Application Data
(63) Continuation of application No. PCT/CN2014/073672, filed on Mar. 19, 2014.

(30) Foreign Application Priority Data
May 22, 2013 (CN) 201310192686.4

(51) Int. Cl. G06F 9/445

(52) U.S. Cl. CPC G06F 8/65
USPC 717/170

(57) ABSTRACT

A method, device, and system are provided for suggesting application update. In the method, the device obtains version information of a running application installed on the terminal device and reports the version information. The terminal device receives a version prompting message based on the version information and stores the version prompting message. When the running application enters into a suspended state in the terminal device, the device extracts the stored version prompting message and displays the version prompting message informing the terminal device to update the suspended application.

### CROSS-REFERENCE TO RELATED APPLICATIONS

This application is a continuation of International Application No. PCT/CN2014/073672, filed on Mar. 19, 2014, which claims priority to Chinese Patent Application No. 201310192686.4, filed on May 22, 2013, both of which are hereby incorporated herein by reference in their entireties.

### FIELD

The present disclosure involves Internet application technologies, especially a method and system for prompting application update.

### BACKGROUND

With the development of the Internet, thousands of applications have sprung up and run on users' terminal devices.

To provide more comprehensive functions, developers consecutively release new versions of the applications and send update promptings to users, indicating that users can update their applications to new versions.

### SUMMARY

As a result, a method, device, and system for prompting application update are disclosed to improve the downloading rate of new application versions.

In the method, the device obtains version information of a running application installed on the terminal device and reports the version information. The terminal device receives a version prompting message based on the version information and stores the version prompting message. When the running application enters into a suspended state in the terminal device, the device extracts the stored version prompting message and displays the version prompting message informing the terminal device to update the suspended application.

A non-transitory storage medium stores the following modules to be executed by a hardware processor. A version reporting module is configured to obtain corresponding version information of a triggered running application installed on the terminal device and to report the obtained version information. An information receiving module is configured to receive and store a version prompting message according to the version information. A prompting module is configured to extract the stored version prompting message after the triggered running application enters into a suspension state, where the version prompting message informs the terminal device to update the suspended application.

A terminal device includes a hardware processor and a non-transitory storage medium accessible to the hardware processor. the hardware processor is configured to: obtain corresponding version information of a triggered running application installed on the terminal device and report the obtained version information; receive and store a version prompting message according to the version information; and extract the stored version prompting message after the triggered running application enters into a suspension state, wherein the version prompting message informs the terminal device to update the suspended application

A system for prompting application update includes the above terminal device.

This section provides a general summary of the disclosure, and is not a comprehensive disclosure of its full scope or all of its features. Further areas of applicability will become apparent from the description provided herein. The description and specific examples in this summary are intended for illustration purposes only and are not intended to limit the scope of the present disclosure.

### BRIEF DESCRIPTION OF THE DRAWINGS

To better explain the technical scheme of the present disclosure, the accompanying drawings necessary for the illustration of example embodiments of the disclosure are briefly described below, and it is apparent to those of ordinary skill in the art that the accompanying drawings only illustrate some embodiments of the disclosure and that other drawings may be obtained according to the accompanying drawings without any innovative efforts.

FIG. 1 shows the flow diagram of the method prompting application update in one embodiment.

FIG. 2 shows the flow diagram of the method prompting application update in another embodiment.

FIG. 3 shows the flow diagram of the method issuing version prompting message based on the setup information and network environment of the triggered running application in FIG. 2.

FIG. 4 shows the flow diagram of the method prompting application update in a third embodiment.

FIG. 5 shows the flow diagram of the method extracting the stored version prompting message for prompting the suspended application when the triggered running application in an embodiment is suspended.

FIG. 6 shows the schematic diagram of an application for prompting update.

FIG. 7 shows the structure diagram of the system prompting application update in one embodiment.

FIG. 8 shows the structure diagram of the system prompting application update in another embodiment.

FIG. 9 shows the structure diagram of the processing module in FIG. 8.

FIG. 10 shows the structure diagram of the extraction module in an embodiment.

FIG. 11 shows the block diagram of partial structure of a mobile phone that is related to embodiment of the present disclosure.

### DETAILED DESCRIPTION OF THE DRAWINGS

For a better understanding of the aim, technical schemes and advantages of the present disclosure, example embodiments are described in detail in connection with the accompanying drawings as follows.

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a example embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The solutions in embodiment of the present disclosure will be clearly and completely described as follows combined with the attached figure of the embodiment of the present disclosure. Apparently, the described embodiments are only part of the embodiments of the present disclosure, but not all embodiments. All other embodiments acquired by a person having ordinary skill in the art, based on the embodiment of this disclosure and without creative work, may be covered in the scope of this disclosure.

The method for prompting application update is carried out by computer programs, whereas the corresponding system for prompting application update is stored in various terminal devices, such as smart phones, tablets, laptops, and desk computers. Data in the devices interacts with that in the background server through the Internet.

The disclosed method, device, and system obtain and report the corresponding version information while the application is triggered and run. The device and system receive and store the version prompting message issued based on this version information. After the triggered running application goes into a suspension state, the stored version prompting message will be extracted for prompting application update. Thus, it is not necessary to forcibly interrupt the running application. The update prompting will be given after the running of application is completed, which will effectively improve the downloading rate of the new version of application.

Developers release new versions of the applications and send update promptings to users, indicating that users can update their applications to new versions. However, update promptings are always displayed when the corresponding applications are running. To update a running application, the user has to interrupt the running application. Therefore, users tend to refuse application update and keep running the application. This causes low downloading rate of new application versions.

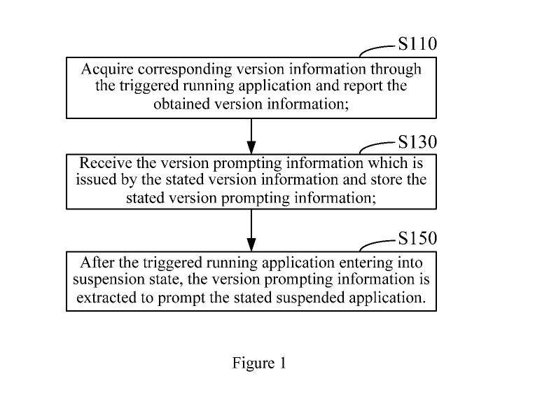

As shown in FIG. 1, an application update prompting method in an embodiment includes the following steps:

Step S110: Obtain corresponding version information of the triggered running application and report the obtained version information.

In the embodiment, the triggered running application may be any application install on a terminal device. When an application in a terminal device is triggered, the version information of the application is obtained and reported to the corresponding background server. The version information includes at least the current version number of the application.

Step S130: Receive and store the version prompting message issued based on the version information.

In the embodiment, the background server issues version prompting message based on the reported version information. The version prompting message, which is received from the background server and stored in local, suggests users to update the application. The version prompting message may include the new version number of the application currently configured in the background server and the description about the improvement of the application.

Step S150: After the triggered running application enters suspension state, extract the stored version prompting message to suggest update of the suspended application.

When an application enters suspension state from running state in the embodiment, the application is probably not being used by the user at that moment. Application update prompting at this time thus will not interrupt the application use.

The version prompting message stored in local is corresponding to the suspended application. The version prompting message is extracted and displayed in the device operation interface so that users can view the information and operate to update the application to the latest version configured in the background server.

In the embodiment, the extracted version prompting message is displayed in the form of a message or update prompting icon, indicating users that the triggered running application can be updated.

Then, users need only to operate on the displayed message or icon to update the application.

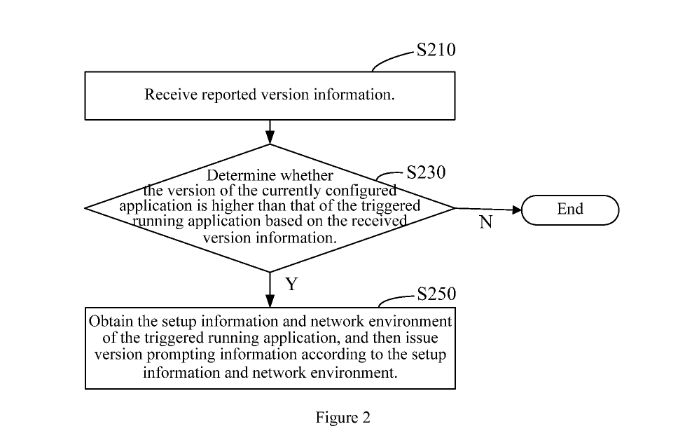

As shown in FIG. 2, the method may include the following steps before step S130:

Step S210: Receive reported version information.

In the embodiment, the background server receives reported version information.

Step S230: Determine whether the version of the currently configured application is higher than that of the triggered running application based on the received version information. If yes, perform step S250. If not, end the operation.

In this embodiment, the version number of the triggered running application in the terminal device is extracted from the received version information. Then, the extracted version number is compared with the version number of the application configured in the background server to determine which version is higher. If the version of the application configured in the background server is higher, the application in terminal devices should be updated. If the extracted version is higher, the application in terminal devices is in the latest version and no update is required.

Step S250: Obtain the setup information and network environment of the triggered running application, and then issue version prompting message.

In this embodiment, the terminal device determines that there is an update version of the running application if the version of the application currently configured in the server is higher than that of the triggered running application. The terminal then obtains the setup information of the application and the network environment of the terminal device to determine whether to suggest update.

The setup information of the triggered running application includes information about the prompting frequency and method, which may be configured by the background server as required or be customized by users.

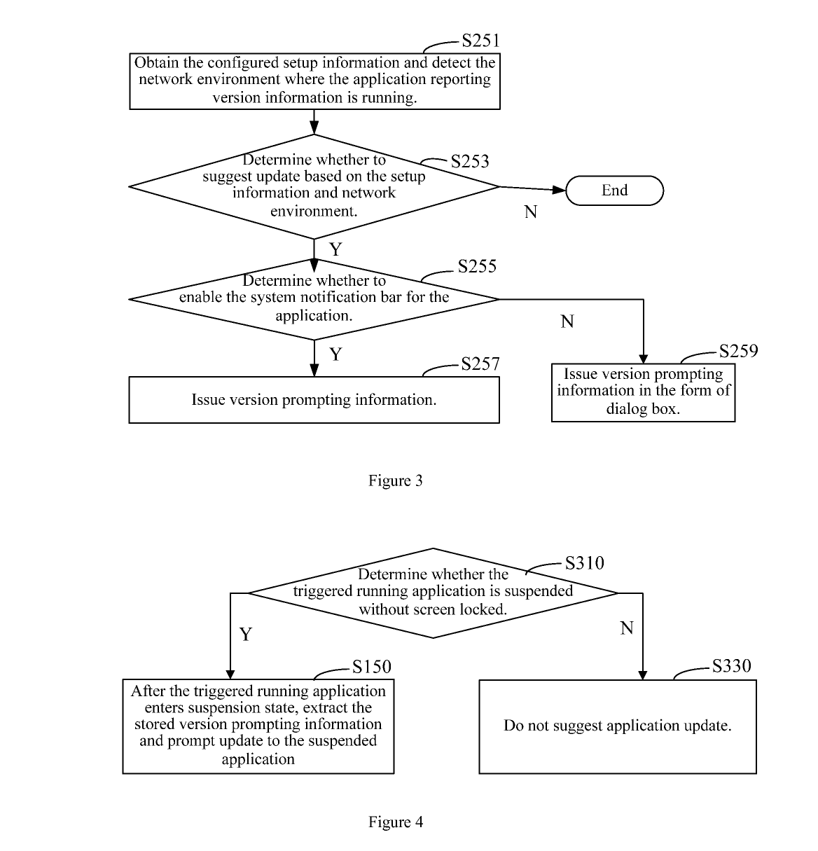

As shown in FIG. 3, step S250 in one embodiment includes the following procedures:

Step S251: Obtain the configured setup information and detect the network environment where the application reporting version information is running.

In the embodiment, the setup information configured at the background server is obtained or the user identification can be obtained from the reported version information, thus obtaining the setup information corresponding to this user identification. While the setup information is obtained, the network environment where the application reporting version information is running is detected. For example, the network may be a Wi-Fi (Wireless Fidelity) network or a GPRS (General Packet Radio Service) mobile data network.

Step S253: Determine whether to suggest update based on the setup information and network environment. If yes, perform step S255. If no, end the operation.

In the embodiment, the terminal device may obtain the latest prompting time of the application because whether to suggest update is based on the prompting frequency in the setup information. In addition, the terminal device determines whether the network is a Wi-Fi network. If there is Wi-Fi and the setup information only allows update with Wi-Fi available, update is suggested. If there is no Wi-Fi and the setup information only allows update with Wi-Fi available, update is not suggested.

Step S255: Further determine whether to enable the system notification bar for the application. If yes, perform step S257. If no, perform step S259.

In the embodiment, if it is determined to perform update prompting to the application, whether to enable system notification bar to this application will be further determined. If yes, the system notification bar is adopted for update prompting without interrupting the running application. If not, a dialog box is used for update prompting.

Step S257: Issue version prompting message.

In the embodiment, version prompting message is issued to the application reporting version information.

Step S259: Issue version prompting message in the form of dialog box.

In the embodiment, a dialog box is displayed for showing the update prompting message. In this case, update can be performed only after the running application is interrupted.

As shown in FIG. 4, this method, in another embodiment, also includes the following steps:

Step S310: Determine whether the triggered running application is suspended without screen-locked. If yes, perform step S150. If no, perform step S330.

In the embodiment, whether the triggered running application is suspended without screen-locked is determined. If yes, other applications are running or no application is used; then, update can be suggested. If no, the triggered running application is not suspended or is screen locked; then, update is not suggested.

Step S330: no application update prompting is made.

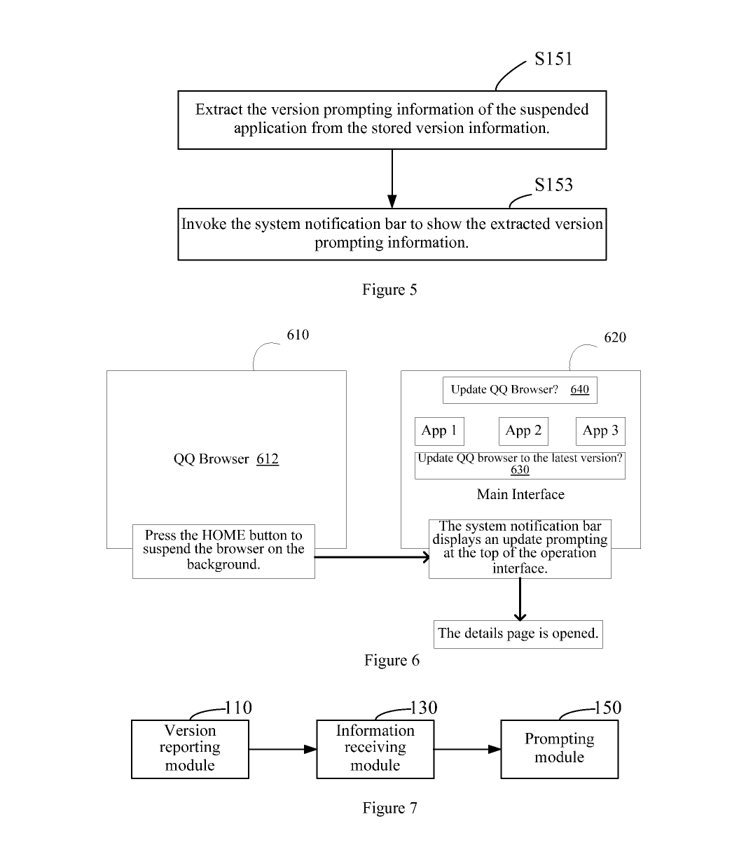

As shown in FIG. 5, step S150, in an embodiment, includes the following procedures:

Step S151: Extract the version prompting message of the suspended application from the stored version information.

In the embodiment, the version prompting message of one or more applications may be stored in local. Then, version prompting message must be extracted based on the application in suspension state.

Step S153: Invoke the system notification bar to show the extracted version prompting message.

In the embodiment, the system notification bar is invoked to display the extracted version prompting message. In preferred embodiments, there may be multiple suspended applications that may be updated. In this case, multiple version prompting messages are extracted. Then, the system notification bar displays the version prompting message in a list so that users can click one of the version prompting messages to update the corresponding application.

The following parts use an embodiment to describe the method for prompting application update. As shown in FIG. 6, the triggered running application in the embodiment is a browser 612 in a tablet 610. When the browser 612 is triggered running, the version information of the browser is obtained and reported to the background server.

Upon receiving the version information, the background server determines whether the version of the currently configured browser is higher than that of the browser on the tablet. If yes, the setup information and network environment are obtained to determine whether to suggest update. If no, update is not required.

After update prompting is confirmed based on the setup information and network environment, whether system notification bar is enabled on the browser is further checked. If yes, version prompting message is issued and stored in the tablet. If no, a dialog box 630 is displayed in the tablet operation interface 620 to suggest browser update.

When a user presses the HOME button of the tablet to suspend the browser 612, the triggered running browser is suspended without screen-locked. Then, the system notification bar at the top of the operation interface 620 of the tablet displays the version prompting message 640. A user can click the information to open the details page for the browser.

As shown in FIG. 7, a system for prompting application update in an embodiment includes a version reporting module 110, an information receiving module 130, and a prompting module 150.

The version reporting module 110 is configured to obtain corresponding version information of the triggered running application and report the obtained version information.

In the embodiment, the triggered running application can be any application in a terminal device. When an application in a terminal device is triggered, the version reporting module 110 obtains the version information of the application and report the information to the corresponding background server. This version information must include at least the current version number.

The information receiving module 130 is configured to receive and store the issued version prompting message.

In the embodiment, the background server issues version prompting message based on the reported version information. Upon receiving the version prompting message, the information receiving module 130 stores it in the device. Version prompting message suggests application update and can include the new version number of the application currently configured in the background server and the description about the improvement of the application.

The prompting module 150 is configured to, after the triggered running application enters suspension state, extract the stored version prompting message to suggest an update to the suspended application.

When an application enters suspension state from running state in the embodiment, the application is probably not being used. The prompting module 150 can suggest update at the time without worrying that the update prompting may interrupt the application use.

The prompting module 150 extracts the locally stored version prompting message which is corresponding to the suspended application. Then, the information is displayed in the device operation interface so that users can view the information and operate to update the application to the latest version configured in the background server.

In an embodiment, the version prompting message extracted by the prompting module 150 is displayed in the form of a message or update prompting icon in the operation interface, indicating users that the triggered running application can be updated.

Now, users only need to operate at the displayed message or icon to update the application.

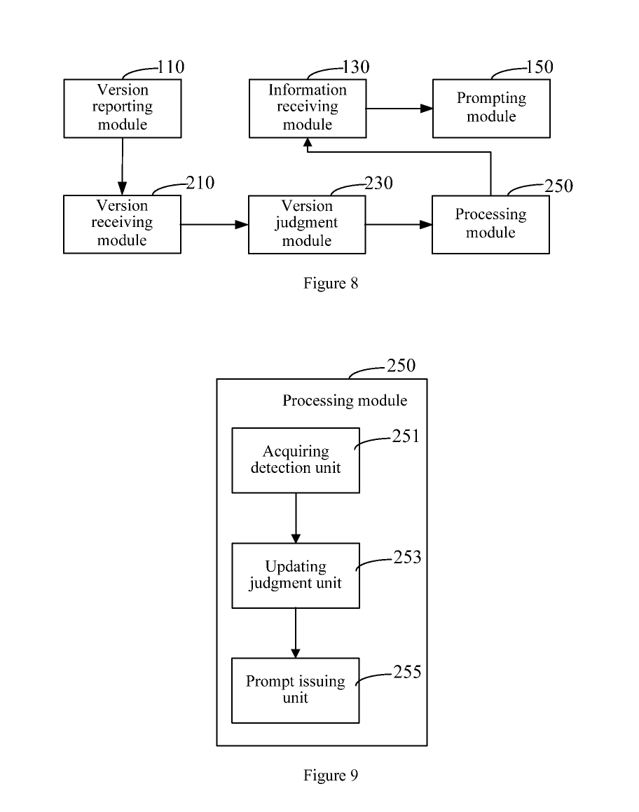

As shown in FIG. 8, in an embodiment, this system also includes version receiving module 210, version determination module 230 and processing module 250.

Versions receiving module 210 is configured to receive the reported version information.

In this embodiment, version receiving module 210 in the background server receives the reported version information.

Version determination module 230 is configured to determine whether the version of the currently configured application is higher than that of the triggered running application based on the received version information; if yes, the processing module 250 will be notified; if not, execution will be stopped.

In this embodiment, the determination module 230 extracts and obtains the version number of the triggered running application in the terminal device from the received version information and compares it with the version of the application currently configured in the background server to determine which version is higher. If the version of the application configured in the background server is higher, the application in terminal devices should be updated. If the extracted version is higher, the application in terminal devices is in the latest version and no update is required.

Processing module 250 is configured to obtain the corresponding setup information and network environment of the triggered running application and issue version prompting message based on the setup information and network environment.

In this embodiment, if the version of the application currently configured in server is detected to be higher than that of the triggered running application, processing module 250 will obtain the corresponding setup information and the network environment where this application performs information transmission to determine whether to provide prompt according to the setup information and network environment.

The setup information of the triggered running application includes information about the prompt frequency, prompting mode and others. It can be configured either at the background server as required or customized by users.

As shown in FIG. 9, in one embodiment, the above-mentioned processing module 250 includes the acquiring detection unit 251, the update determination unit 253 and the prompt issuing unit 255.

Acquiring detection unit 251 is configured to acquire the configured setup information and detect the network environment where the application reporting version information is running;

In this embodiment, the acquiring detection unit 251 obtains the setup information configured at the background server or extracts user identification from the reported version information, and thus acquiring the setup information corresponding to this user identification. In addition, this unit also detects the network environment where the application reporting version information is running while acquiring the setup information. For example, this network may be a Wi-Fi (wireless fidelity) wireless network, a GPRS (General Packet Radio Service) mobile data network, or any other communication network.

Update determination unit is configured to determine whether update prompting is required based on the setup information and network environment; if yes, the prompt issuing unit 255 will be notified; if not, execution will be stopped.

In this embodiment, the update determination unit 253 acquires the latest prompt time of the application and determines whether the appropriate prompt information is reached according to the prompt frequency in the setup information and further determines whether the configured network environment is WiFi wireless network; if yes, notify the prompt issuing unit 255 to update the prompt information; if not, no update prompt will be made to this application.

The prompt issuing unit 255 is configured to determine whether system notification bar is enabled for the stated application; if yes, the version prompting message will be issued; if not, the dialog box prompting unit 257 will be notified.

In this embodiment, if it is determined to perform update prompt to this application, the prompt issuing unit 255 further determines whether to enable system notification bar to this application; if yes, the system notification bar is adopted for update prompting without interrupting the running application. If no, the dialog box prompting unit 257 is notified to enable dialog box for update prompting.

The dialog box prompting unit 257 is configured to enable the dialog box for displaying the version prompting message.

In this embodiment, the dialog box prompting unit 257 prompts updating in the form of dialog box. In this case, update can be performed only after the running application is interrupted.

In one embodiment, this system also includes suspend determination module which is configured to determine whether the triggered running application is suspended without screen locked; if yes, the prompting module 150 will be notified; if not, no updating prompt will be made to this application.

In this embodiment, the determination module determines whether the triggered running application is in suspended state without screen-locked; if yes, it indicates other applications are running or no application is used; now it may inform the prompting module 150 for update prompting; if not, it indicates that this triggered running application is not suspended or it is in screen locked. In this event, no update prompt will be made.

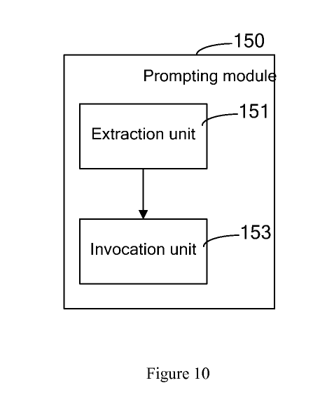

As shown in FIG. 10, in one embodiment, the above-mentioned prompting module 150 includes the extraction unit 151 and the invocation unit 153.

The extraction unit 151 is configured to extract the corresponding version information of the suspended application from the stored version prompting message.

In this embodiment, version prompting message of one or more applications may be included in the locally stored version prompting message. In this case, the extraction unit 151 needs to extract the version prompting message based on the current suspended application.

The invocation unit 153 is configured to invoke the system notification bar to display the extracted version prompting message.

In this embodiment, the invocation unit 153 invokes the system notification bar to display the extracted the version prompting message. In preferred embodiments, there may be multiple suspended applications that may be updated. Accordingly, multiple version prompting messages are extracted. In this case, the invocation unit 153 will invoke the system notification bar to display multiple version prompting messages in the form of list so that users can click one of the version prompting messages to update the corresponding application.

In the above-mentioned method and system for prompting application update, while the application is triggered and run, they will obtain and report the corresponding version information, thus to receive and store the version prompting message issued based on this version information. After the triggered running application goes into the suspension state, the stored version prompting message will be extracted for prompting application update. It is not necessary to forcibly interrupt the running application. The update prompting will be given after the running of application is completed, which will effectively improve the downloading rate of the new version of application.

It is understood by the ordinary technicians of this field that all or part of the process to realize the embodiment methods can be completed by relevant hardware with computer program orders, and the programs can be stored in a storage medium readable by the computer. During the program execution, it may include the process for embodiments of above methods. The storage mediums can be disk, compact disk, read-only memory (ROM) or random access memory (RAM), etc.

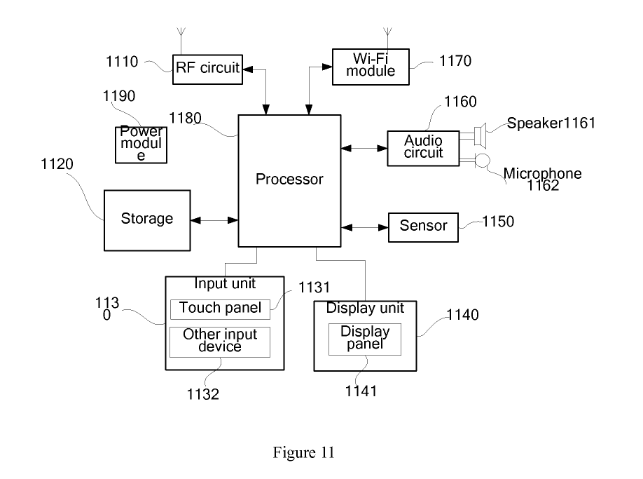

The embodiment of the present disclosure provides the terminals involved in the above embodiment. For illustration purpose, FIG. 11 only illustrates the part related to the embodiment of the present disclosure. Refer to the method part of the embodiment of the present disclosure for specific technical details that are not covered here. This terminal, which may be tablet PC, PDA (Personal Digital Assistant), POS (Point of Sales), board computer, and other terminal device, is configure to implement the method for prompting application update provided in the above embodiments. The following part delivers a description about terminal by taking mobile phone as an example:

FIG. 11 is a block diagram showing the partial structure of the mobile phone related to the terminal provided by the embodiment of the present disclosure. As shown in FIG. 11, the mobile phone includes: RF (Radio Frequency), a circuit 1110, storage 1120, an input unit 1130, a display unit 1140, a sensor 1150, an audio circuit 1160, a wireless fidelity (WiFi) module 1170, a processor 1180, a power module 1190, and such components. It can be understood by a person having ordinary skill in the art that the example shown in FIG. 11 does not constitute a limitation to the mobile phone. It may include more or less components, or combine some of the parts, or use different arrangement of components

Below is an introduction to the components of mobile phone in conjunction with FIG. 11.

The RF Circuit 1110 may be configured to send and receive signal in the processes of messages sending and receiving or communications. For example, it may send the downstream data received from Base Station to Processor 1180 for processing, and at the same time it sends the designed upstream data to Base Station. Generally speaking, the RF Circuit includes, but not limited to, antenna, at least one amplifier, transceiver, coupler, low noise amplifier (LNA) and duplexer, etc. In addition, RF Circuit 110 is capable of contacting with other equipment by wireless communication and network. The aforementioned wireless communication may use any communication standard or protocol, including but not limited to GSM (Global System of Mobile communication), GPRS (General Packet Radio Service), CDMA (Code Division Multiple Access), WCDMA (Wideband Code Division Multiple Access), LTE (Long Term Evolution), email, and SMS (Short Messaging Service).

The storage 1120 may be configured to store software programs and modules. The processor 1180 executes various functions and data processing of the mobile phone through the software program stored in Storage 1120. The storage 1120 mainly includes the program storage area and data storage area, among which the program storage area can store the operation system and the application needed by at least one function (like voice broadcast function, image playback function etc.); and the data storage area can store data established based on the use of the mobile phone (like voice data, phone book etc.). Furthermore, the storage 1120 can also include high speed random access memory and nonvolatile memory, for instance, it can include at least one disk storage device, flash memory, or other volatile solid-state storage device.

The input unit 1130 may be configured to receive the entered number or character information, and generate key signal input related to user settings and function control of mobile phone 1100. Specifically, the input unit 1130 may include a touch panel 1131 and other input device 1132. The touch panel 1131, also known as a touch screen, can collect the touch operation on or near it (such as operations by user on or near the touch panel 1131 using finger, touch pen or other appropriate object) and drive the corresponding linked device through the preset program. Optionally, the touch panel 1131 may include a touch detection unit and a touch controller. Wherein the touch detection unit detects the user's touch position and the signal brought by the touch operation and transmit the signal to the touch controller; while the touch controller receives the touch information from the touch detection unit, converts it into contact coordinates, send it to the processor 1180 for processing, and receives and executes the commands from processor 1180. Furthermore, various kinds of touch panels, including resistive, capacitive, infrared and surface acoustic wave and other types of touch panels can be used as the touch panel 1131. Except for the touch panel 1131, the input unit 1130 can include other input device 1132. Specifically, the other input device 1132 may include, but are not limited to, one or more of the physical keyboard, function keys (such as volume control buttons, on/off keys, etc.), trackball, mouse, and joystick.

The display unit 1140 may be configured to display the information input by users or provided to users and the mobile phone's various menus. The display unit 1140 may also include the display panel 1141 which is optional, a LCD (Liquid Crystal Display), an OLED (Organic Light-Emitting Diode) and others. Furthermore, the touch panel 1131 can cover the display panel 1141. When the touch panel 1131 detects the touch operation on or near it, it sends the touch signal to the processor 1180 for determining the type of touch event, and then the processor 1180 provides appropriate visual output on the display panel 1141 according to the type of touch event. Although in FIG. 11, the touch panel 1131 and the display panel 1141 serve as two separate parts to achieve the input and output functions of the mobile phone, in some embodiments, they can be integrated to achieve the input and output functions of mobile phone.

Mobile phone 1100 may also include at least one kind of sensor 1150, such as light sensor, motion sensors or other sensors. Specifically, the light sensor may include an ambient light sensor and a proximity sensor, wherein the ambient light sensor can adjust the brightness of display panel 1141 according to the brightness of ambient light and the proximity sensor can turn off the display panel 1141 and/or backlighting upon the mobile phone near ears of users. As one of motion sensors, the accelerometer sensor can detect the acceleration in all directions (typically axis), and can detect the magnitude and direction of gravity in still state, which can be used for applications identifying posture of mobile phone (such as horizontal and vertical screen switching, related games, magnetometer posture calibration) and vibration recognition related functions (e.g. pedometer, percussion), etc.; For other sensors, such as gyroscope, barometer, hygrometer, thermometer, infrared sensors, that can be configured for mobile phone, we do not describe them in detail here.

The audio circuit 1160, speaker 1161, and microphone 1162 can provide the audio interface between user and the phone. Audio circuit 1160 can receive audio data and convert it into electrical signal before transmitting it to the speaker 1161 which will converts the electrical signal into acoustical signal and output; on the other hand, the microphone 1162 converts the received acoustical signal into electrical signal which will be received and converted into audio data by the audio circuit 1160 and output to the processor 1180 for processing, and then sent to other device like another mobile phone via the RF circuit 1110 or the audio data is output to the storage 1120 for further processing.

WiFi is a kind of short-range wireless technology. Through the WiFi module, mobile phone can help users receiving and sending emails, browsing web pages, accessing to streaming media and so on. It provides users with wireless broadband Internet access. Although FIG. 11 shows a WiFi module 1170, but we know it is not an essential part of mobile phone 1100 and can be omitted within the scope of not changing the nature of the present disclosure.

The processor 1180 is the control center of a mobile phone. It uses a variety of interfaces and circuits to connect various parts of the entire phone. By running or executing the software program and/or modules stored in storage 1120 and invoking the data stored in storage 1120, processor 1180 executes the various functions of the phone and processing data, and thus monitoring the overall mobile phone. Optionally, the processor 1180 may include one or more processing units; however, it is preferred to integrate the application processor and modem processor into processor 1180, wherein the application processor mainly processes the operating system, user interface and application and the modem processor mainly deals with wireless communications. It is understood that the above modem processor does not have to be integrated into the processor 1180.

Mobile phone 1100 further includes a power supply 1190 (such as batteries) for supplying power to various components, preferably, the power supply 1190 can be logically connected to the processor 1180 via the power management, and thus achieving the purpose of managing charging, discharging, and power consumption.

The mobile phone 1100 may also include a camera, Bluetooth module and so on which are not presented in the figure. We do not discuss them in detail here.

In the embodiment of the present disclosure, the corresponding program command of the above system for prompting application update is stored in storage 1120. The processor 1180 included in the above terminal is configured to execute the system for prompting application update.

The aforementioned embodiments illustrate several kinds of implementation modes of the present disclosure. The embodiments, however, do not limit the scope of this disclosure. It should be noted that, ordinary technical staff in this field can make a number of modifications or improvements in the condition of without departing from the concept of the present disclosure. These modifications and/or improvements are still within the scope of the present disclosure. Therefore, the scope of the present disclosure shall be subject to the claims.

What is claimed is:

1. A method for prompting application update, comprising:
obtaining, by a terminal device, version information of a running application installed on the terminal device and reporting the version information;
receiving, by the terminal device, a version prompting message based on the version information and storing the version prompting message; and
when the running application enters into a suspended state in the terminal device, extracting a stored version prompting message and displaying the version prompting message informing the terminal device to update the suspended application.

2. The method of claim 1, before receiving the version prompting message based on the version information and storing the version prompting message, the method further comprising:
receiving, by the terminal, the reported version information;
based on the received version information, determining whether there is an updated version of a triggered running application; and
if yes, acquiring corresponding setup information and a network environment of the triggered running application and displaying version prompting message according to the setup information and the network environment.

3. The method of claim 2, wherein acquiring the corresponding setup information and the network environment of the triggered running application and displaying version prompting message according to the setup information and the network environment comprises:
acquiring configured setup information and detecting the network environment of the terminal device; and
determining, based on the setup information and the network environment, whether to allow displaying the version prompting message; if yes, further determining whether the application enables a system notification bar, if yes, displaying the version prompting message in the system notification bar.

4. The method of claim 2, further comprising:
determining whether a screen is locked when the triggered running application is suspended;
if the screen is not locked, extracting the stored version prompting message and displaying the version prompting message informing the terminal device to update the suspended application after the triggered running application is suspended; and
if the screen is locked, displaying no version prompting message.

5. The method of claim 1, wherein extracting the stored version prompting message and displaying the version prompting message informing the terminal device to update the suspended application comprises:
extracting the version prompting message of the suspended application from stored version information; and
invoking a system notification bar to display the extracted version prompting message.

6. A non-transitory storage medium, comprising the following modules to be executed by a hardware processor:
a version reporting module configured to obtain corresponding version information of a triggered running application installed on a terminal device and report the obtained version information;
an information receiving module configured to receive and store a version prompting message according to the version information; and
a prompting module configured to extract a stored version prompting message after the triggered running application enters into a suspension state, wherein the version prompting message informs the terminal device to update a suspended application.

7. The non-transitory storage medium of claim 6, further comprising:
a version receiving module configured to receive the reported version information;
a version determination module configured to determine whether the version of a currently configured application is higher than that of the triggered running application based on the received version information; if yes, notify a processing module; and
the processing module is configured to acquire setup information and network environment of the triggered running application, through which the version prompting message is issued.

8. The non-transitory storage medium of claim 7, wherein the processing module comprises:
an acquiring detection unit configured to acquire the setup information and detect the network environment of the triggered running application;
an updating determination unit configured to determine whether to provide update prompting according to the setup information and the network environment; if yes, notify a prompt issuing unit; and
the prompt issuing unit is configured to determine whether a system notification bar is enabled for the application; if yes, display the version prompting message in the system notification bar.

9. The non-transitory storage medium of claim 7, further comprising:
a suspension determination module configured to determine whether the triggered running application has been suspended without screen locked; if yes, notify the prompting module.

10. The non-transitory storage medium of claim 6, wherein the prompting module comprises:
an extraction unit configured to extract the corresponding version information of the suspended application from the stored version prompting message; and
an invocation unit configured to invoke a system notification bar to display the extracted version prompting message.

11. A terminal device comprising a hardware processor and a non-transitory storage medium accessible to the hardware processor, the hardware processor is configured to:
obtain corresponding version information of a triggered running application installed on the terminal device and report the obtained version information;
receive and store a version prompting message according to the version information; and
extract the stored version prompting message after the triggered running application enters into a suspension state, wherein the version prompting message informs the terminal device to update the suspended application.

12. The terminal device of claim 11, wherein the hardware processor is configured to:
receive the reported version information;
determine whether the version of the currently configured application is higher than that of the triggered running application based on the received version information; if yes, notify a processing module; and
acquire the setup information and network environment of the triggered running application, through which the version prompting message is issued.

13. The terminal device of claim 12, wherein the hardware processor is configured to:
acquire the setup information and detect the network environment of the triggered running application;
determine whether to provide update prompting according to the setup information and the network environment; if yes, notify a prompt issuing unit; and
determine whether a system notification bar is enabled for the application; if yes, display the version prompting message in the system notification bar.

14. The terminal device of claim 12, wherein the hardware processor is configured to:
determine whether the triggered running application has been suspended without screen locked; if yes, notify the prompting module.

15. The terminal device of claim 11, wherein the hardware processor is configured to:
extract the corresponding version information of the suspended application from the stored version prompting message; and
invoke a system notification bar to display the extracted version prompting message.
